(19) United States
(12) Patent Application Publication
(10) Pub. No.: US 2013/0163008 A1
(43) Pub. Date: Jun. 27, 2013

(54) METHODS FOR PRINT AREA OPTIMIZATION

(71) Applicants: Mark Joseph Edwards, Lexington, KY (US); John Thomas Writt, Lexington, KY (US)

(72) Inventors: Mark Joseph Edwards, Lexington, KY (US); John Thomas Writt, Lexington, KY (US)

(21) Appl. No.: 13/336,036

(22) Filed: Dec. 23, 2011

(51) Int. Cl. G06K 15/02

(52) U.S. Cl. 358/1.6

(57) ABSTRACT

A method of optimized printing that includes accumulating a plurality of print jobs from at least one application, each of the plurality of print jobs containing print content; converting each of the plurality of print jobs to an image format; automatically arranging the print content of each of the converted print jobs, and printing at least a portion of a first converted print job of the plurality of print jobs and at least a portion of a second converted print job of the plurality of print jobs on a single media sheet.

### CROSS REFERENCE TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates to printing, and, more particularly, to optimizing print area in printing.

2. Description of the Related Art

Many applications force a user to print a larger portion of a document than the user would like to print. For example, when a user tries to print an e-mail, e-mail clients provide the entire e-mail for preview and for printing. The options available for the user are to print the entire e-mail, including undesired or unnecessary portions, or to copy and paste selected portions to a separate application (e.g., word processing application) and then print the selected portions from there. The first option fails to optimize print area and may use more paper than the user desires, and the second option may be burdensome and time-consuming.

Existing applications provide methods to print just the information the user wishes to print. For example, Lexmark's Web ToolBar allows printing of a selected portion from a web page. While this application allows printing of a specific portion, it does not allow multiple discontinuous selections from the same web page. This solution only allows the user to choose one particular portion from a web page to print.

There are other applications that may allow multiple discontinuous selections from a web page, such as the Google Chrome extension called Print Plus, but this application lacks the ability to allow multiple discontinuous selections in print jobs generated by multiple applications.

Another method for a user to print selected portions of a print job is to edit a to-be-printed document in a word processor, such as Microsoft Word. In this method, the user can reduce a print job down to just the snippets the user wants to print. However, this reduction applies to and is saved in the original document, which is typically not desired.

A broader problem in selecting portions to print is how to optimize the print area available in one page. When a user selects multiple portions to print in print jobs that come from multiple documents or are from different applications, there is a tendency for the selected portions to only take up a minimal amount of space on a page. Even if selection of portions to print within each application is possible, followed by printing of each selection on a page, the small amount of printing done per page is not efficient in optimizing the available print area per page. It is cumbersome and time-consuming to collect these selections into a single print job via copying and pasting the selections from multiple applications to a word processing application. Moreover, the time-consuming copy-paste method may not maintain the original formatting of the print job which may not be desirable.

Accordingly, there is a need for a system that enables a user to more easily select portions of print jobs even if the print jobs are from multiple applications and optimize the print area by formatting those portions in order to print them in a minimum number of pages.

### SUMMARY

According to one example embodiment of the present disclosure, there is provided a method of optimized printing that includes accumulating a plurality of print jobs from at least one application, each of the plurality of print jobs containing print content, converting each of the plurality of print jobs to an image format, automatically arranging the print content of each of the converted print jobs and printing at least a portion of a first converted print job of the plurality of print jobs and at least a portion of a second converted print job of the plurality of print jobs on a single media sheet.

In one aspect of the first embodiment, automatically arranging the print content of each of the converted print jobs may include automatically concatenating the print content from the second converted print job to the first converted print job. In another aspect, a margin may be inserted between the print content from the second converted print job and the print content in the first converted print job. In yet another aspect, automatically arranging the print content of each of the converted print jobs may include removing blank rasters in each of the converted print jobs.

In another aspect of the first example embodiment, automatically arranging the print content of each of the converted print jobs may include deleting portions of the print content in each of the converted print jobs. In yet another aspect, the automatically arranging may include modifying positions of the print content.

In an aspect of the first example embodiment, the plurality of print jobs that are sent from the at least one application to an imaging device may be intercepted prior to the accumulating of the plurality of print jobs. In another aspect, the intercepting may be performed on short jobs. In yet another aspect, the intercepting of the plurality of print jobs may be performed on print jobs that are generated from a specific application.

In still another aspect of the example embodiment, an arrangement of print content may be automatically printed once the page is filled with kept portions. In another aspect, the arrangement of the kept portions may be stored.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is a block diagram of a document processing system.

FIG. 2 is one example flowchart of a method of optimizing print area.

FIGS. 3A and 3B illustrate one example embodiment of arranging print content in a page by automatically searching and removing blank rasters in an image file for use in conjunction with the method of FIG. 2.

FIG. 4 is one example flowchart of a second method of optimizing print area.

FIGS. 5A and 5B illustrate one example embodiment of a user selecting portions of an image file to delete for use in conjunction with the method of FIG. 4.

FIGS. 6A and 6B illustrate one example embodiment of modifying positions of the kept portions to allow users to optimize the print area of a page for use in conjunction with to the method of FIG. 4.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the descriptions below.

These computer program instructions may also be stored in a non-transitory computer-readable memory that may direct a computer or other programmable data processing apparatus to function in a particular manner, such that the instructions stored in the computer-readable memory produce an article of manufacture including an instruction means that implements the function specified in the block or blocks. The computer program instructions may also be loaded onto a computer or other programmable data processing apparatus to cause a series of operational steps to be performed on the computer or other programmable apparatus to provide a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, may be implemented by special purpose hardware-based computer systems that perform the specified functions or steps or by combinations of special purpose hardware and computer instructions.

Disclosed are systems and methods for optimizing print area. According to one example embodiment of the present disclosure, a method for optimizing print area includes accumulating print jobs from at least one application. The print jobs are then converted into an image format such as, for example, a bitmap or a jpeg format. Portions of the converted print jobs with white spaces or blank rasters may be deleted, thereby generating kept portions of each of the converted print jobs. The kept portions of the converted print jobs may then be automatically arranged into a page such that white space is minimized

For purposes of the present disclosure, it will be appreciated that the one or more files may consist of documents, photos or any other file that may be used to generate or produce a printed output on a media. The process for printing the one or more files may require that the one or more of these files be processed and/or reassembled into a format that resembles that which is displayed on an interface when the one or more files are accessed. If the one or more files displayed on or retrieved by the imaging device are not in a format that the imaging device recognizes or is capable of printing, a transform or conversion process may be performed on the one or more files in order to convert the one or more files into a format recognizable by the imaging device, i.e., a printable format. Printable formats may include, but are not limited to, PCL, PostScript, .jpeg and PDF formats.

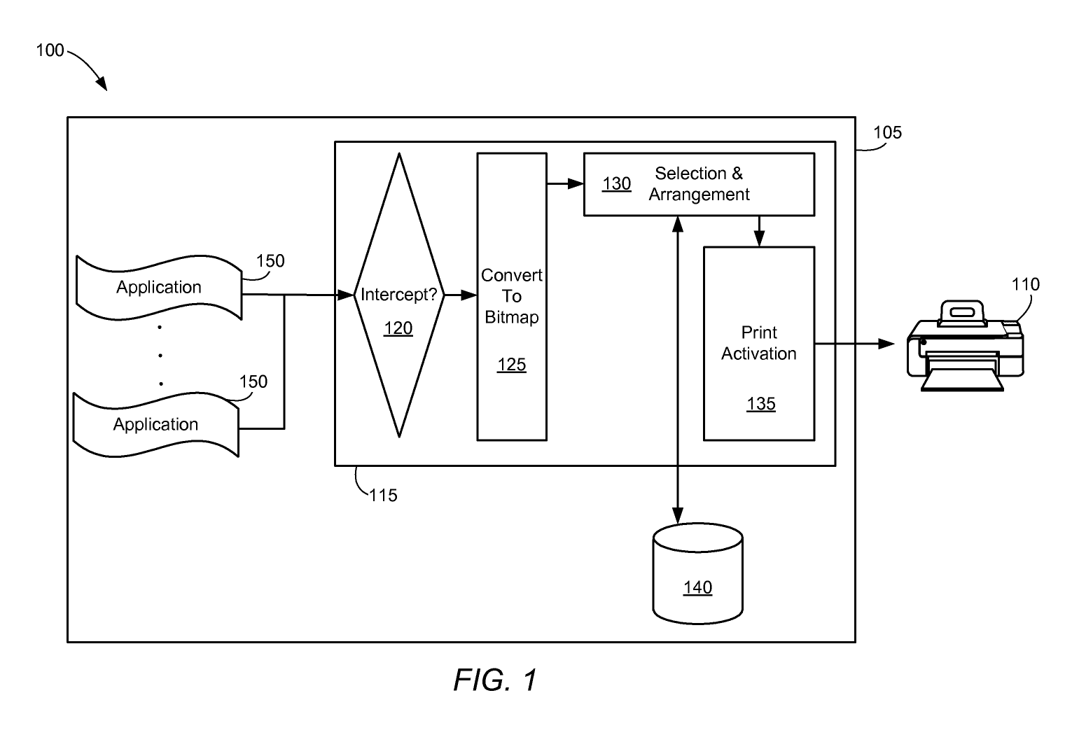

Referring to FIG. 1, there is shown a block diagram of a document processing system 100 including a client device 105 that may be communicatively connected to an imaging device 110, according to one example embodiment. Client device 105 may include a print area optimization application 115 comprising a print job interception module 120, a conversion module 125, a selection and arrangement module 130 and a print activation module 135. Client device 105 may also include at least one application 150 that may be capable of generating a print job. Client device 105 may further include a storage module 140.

Client device 105 may be connected to imaging device 110, as shown in FIG. 1. Client device 105 may be connected to imaging device 110 via a communication link, which may be established by a wired or wireless connection such as, for example, an Ethernet connection. Client device 105 may be a computer or processor-based device capable of communicating with a communications network via a signal, such as a wireless frequency signal or a direct wired communication signal. A respective communication interface associated with client device 105 may facilitate communications between client device 105 and imaging device 110.

Client device 105 may include a processor (not shown) and a computer-readable medium (not shown), such as a random access memory (RAM), coupled to the processor. The processor may execute computer-executable program instructions stored in memory. Computer executable program instructions stored in memory may include a printer driver application program, or print area optimization application 115. The printer driver engine or module may be adapted to implement a set of instructions adapted to convert data to a suitable format for printing by imaging device 110.

Client device 105 may include in its memory (not shown) software or firmware including program instructions which, when executed, function as an application for optimizing the print area when printing. Such instructions will be referred to herein as print area optimization application 115.

Print area optimization application 115 may be part of a print driver that is installed and is executed on client device 105. In an alternative example embodiment, print area optimization application 115 may be a separate application that functions in conjunction with the print driver. In yet another alternative example embodiment, print area optimization application 115 may be stored in a controller of a multi-function imaging device that receives data from a scanning device, processes the data to optimize print area as will be described in greater detail below, and sends the processed data to imaging device 110 for printing.

In one alternative example embodiment, print area optimization application 115 may be enabled or disabled by a user of client device 105. Disabling print area optimization application 115 may allow client device 105 to send print jobs from at least one application 150 to imaging device 110 without any form of interception. A disabled print area optimization application 115 may cause client device 105 to process the print jobs and communicate the print jobs to imaging device 110 as it normally does. In an example embodiment where print area optimization application 115 is enabled, different modules in print area optimization application 115 may be enabled, thereby activating functions of each of the different modules, as will be described in greater detail below.

As set forth above, print area optimization application 115 may include modules with specific functions such as, for example, print job interception module 120, conversion module 125, selection and arrangement module 130 and print activation module 135. It will be understood that in some example embodiments, some of the aforementioned modules may be part of an application different from print area optimization application 115 but may still function in conjunction with each other.

If print area optimization application 115 is enabled, print job interception module 120 may intercept print jobs sent by at least one application 150. In one alternative embodiment, print job interception module 120 may intercept print jobs sent by a specific application. For example, print job interception module 120 may be configured to intercept only print jobs that were generated from a web browser or from a word processing document. The specific application that will be used to determine whether a print job will be intercepted or not may be set by an administrator or user of client device 105.

In another example embodiment, print job interception module 120 may intercept one or more print jobs that satisfy at least one condition. The conditions may be print jobs with a predetermined amount of blank rasters which may classify the print jobs as short print jobs. For example, print job interception module 120 may be configured to intercept print jobs with print content that occupies only half of a page or less than half of the page.

Print area optimization application 115 may also include conversion module 125 that converts the print jobs sent by print job interception module 120 into an image file. The format of the image files may be, for example, bitmap, jpeg, tiff, gif or png. If the intercepted print jobs include more than one page, conversion module 125 may convert each page into a separate image file.

Print area optimization application 115 may include a selection and arrangement module 130 which may be used to delete portions of print jobs, thereby generating kept portions and arranging the kept portions for printing. Selection and arrangement module 130 may be implemented with a graphical user interface that allows the user of client device 105 to select parts of the image files that the user wishes to delete or keep. The kept portions may be automatically arranged in a page to minimize white space in the page or may be arranged by the user, as will be explained in greater detail below.

Print area optimization application 115 may also include print activation module 135, which may render a final arrangement of the kept portions into device specific pages and send the rendered pages to imaging device 110 for printing. Print activation module 135 may be part of the print driver which may be in communication with a controller of imaging device 110. In some example embodiments, print activation module 135 may facilitate communication between client device 105 and imaging device 110 and may provide formatted print data corresponding to the final arrangement of the kept portions to imaging device 110.

Client device 105 may include storage module 140 which may store an arrangement of kept portions of converted print jobs in a storage location such as, for example, a database and/or a local repository in client device 105. In one alternative example embodiment, storage module 140 may be a memory of client device 105. In some example embodiments, selection and arrangement module 130 may retrieve a stored arrangement of kept portions of a print job for further selection of portions to be deleted or for modifying positions of the kept portions to generate a new arrangement of the kept portions, and for sending the new arrangement to print activation module 135 for printing.

Application 150 may be executed in client device 105. Application 150 may produce a print job to be sent to print area optimization application 115. Application 150 may be a word processor capable of producing documents that may be printed. Application 150 may also be a web browser capable of producing a print job from web pages accessed by a user of client device 105. Another application 150 may also be executed in client device 105 that may generate another set of print jobs that may be sent to the print area optimization application 115. In one example embodiment, if two sets of print jobs generated by a first application 150 and a second application 150, respectively, are intercepted by print job interception module 120, the two sets of print jobs may be converted to image files and accumulated in selection and arrangement module 130. The two sets of print jobs may be combined and arranged into one page in selection and arrangement module 130, as will be discussed in greater detail below.

Imaging device 110 may be any device capable of printing or producing a hard copy data file or document stored in electronic form, such as a laser, inkjet or dot matrix printer or multi-function printing device that has the capability of performing other functions, such a faxing, e-mailing, scanning and/or copying, in addition to printing.

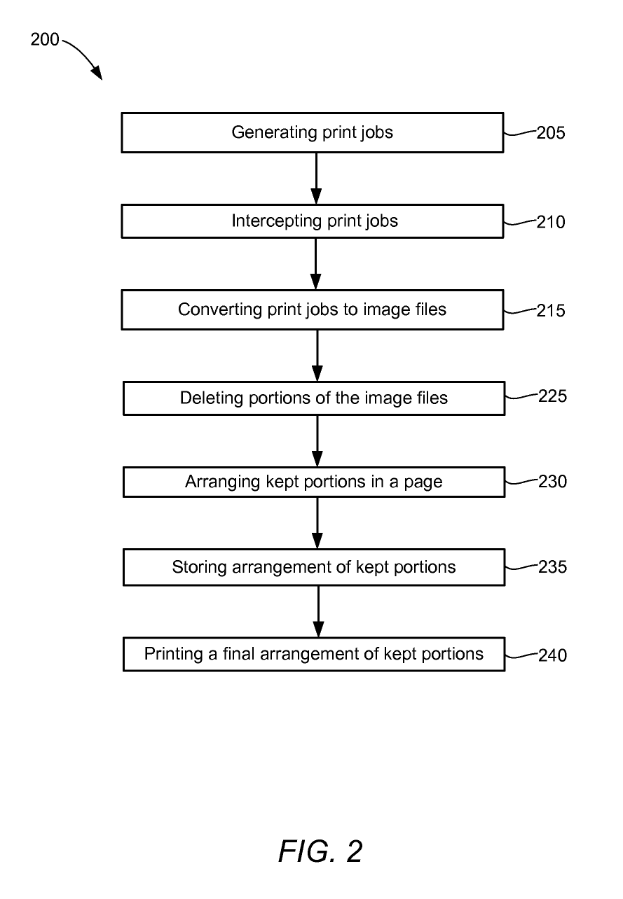

Referring to FIG. 2, there is shown one example flowchart 200 of a method of optimizing print area as performed by print area optimization application 115. At block 205, application 150 may generate a print job. As set forth above, application 150 may be a word processor that is capable of producing print jobs to be sent for imaging device 110 for printing. Application 150 may also be a web browser or an image editing application. It will be appreciated by one of ordinary skill in the art that there may be other types of applications that may be executed in client device 105 that may generate print jobs to be sent to imaging device 110 for printing.

The print job generated by application 150 may be transmitted to print area optimization application 115 and may be intercepted by print job interception module 120 (at block 210). Print job interception module 120 may intercept print jobs when print area optimization application 115 is enabled in client device 105. Print job interception module 120, upon intercepting at least one print job, may keep the print jobs in a buffer. The buffer may hold print jobs sent from several different applications.

In one example embodiment, print job interception module 120 may intercept all print jobs sent to imaging device 110 for printing. In one alternative example embodiment, print job interception module 120 may intercept only print jobs that are flagged for interception. For example, print jobs generated by web browsers may be flagged for interception, and print job interception module 120 may intercept only those print jobs that were sent from web browsers for printing in imaging device 110.

In another alternative example embodiment, print job interception module 120 may only intercept print jobs that are considered short print jobs. For example, print jobs which only cover less than half a sheet of paper may be tagged as short print jobs and may be intercepted by print job interception module 120. Other characteristics of print jobs may be used as criteria to tag those print jobs for interception. Examples of other characteristics may include, but are not limited to, the color content or the estimated amount of ink or toner to be used on the print job.

In still another alternative example embodiment, print job interception module 120 may intercept print jobs upon a user's confirmation. For example, the user may be asked every print job sent from application 150 to imaging device 110 for printing whether the user prefers to have the print job intercepted and kept in a buffer, or if the user prefers to send the print job to imaging device 110 for immediate printing.

At block 215, conversion module 125 may convert the print jobs to a graphics file format, thereby generating image files where each image file corresponding to each page of the print jobs. As set forth above, the image files may be in any graphics format such as, for example, bitmap, jpeg, png or tiff. Conversion module 125 may convert each page of the print jobs to image files to allow basic image portion manipulations on each page, as will be described in greater detail below.

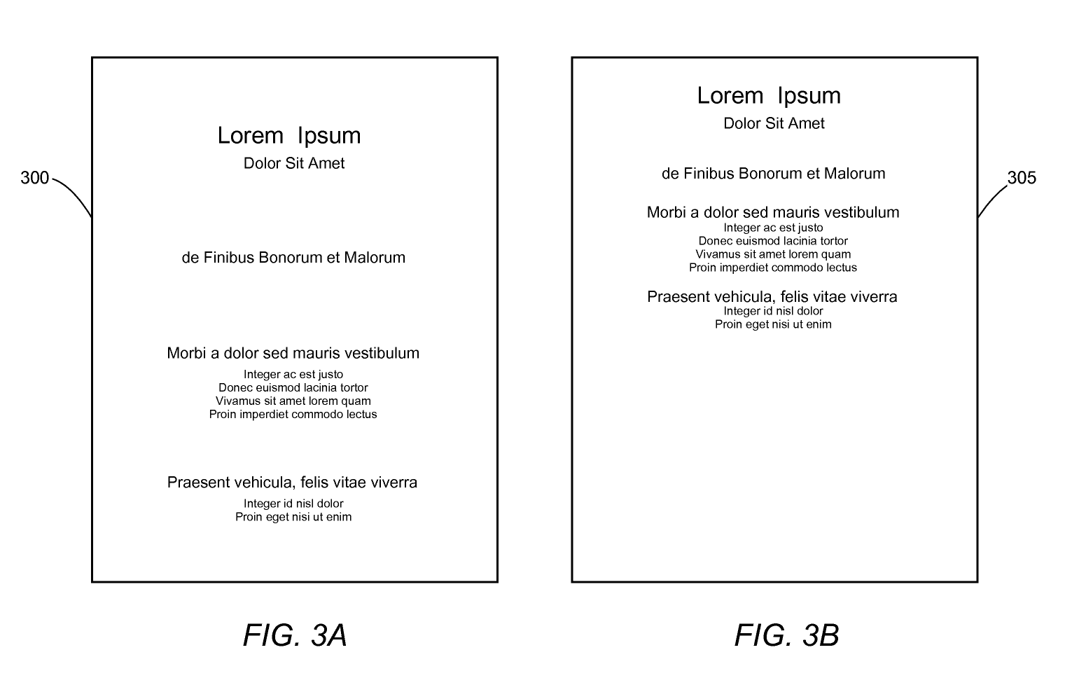

At block 225, selection and arrangement module 130 may select portions of the image files to be deleted, thereby generating kept portions of the image files. In one alternative example embodiment shown in FIGS. 3A and 3B, selection and arrangement module 130 may arrange print content in a page by automatically searching and removing blank rasters in an image file. For example, selection and arrangement module 130 may automatically search for blank rasters in a first image file 300, which may typically be located at the top and bottom of the image file but may also be in between texts as shown in first image file 300. Upon detection of the blank rasters, selection and arrangement module 130 may automatically delete these blank rasters, thereby generating kept portions in a modified first image file 305. Deleting blank rasters allows for more space in the modified first image file 305, and such space may be occupied by non-blank rasters from another print job or from a second image file.

It will be understood that the deleted portions refers to portions of the image files that are not to be sent to imaging device 110 for printing and that the kept portions refer to portions of the image files that may be arranged in at least one page to optimize print area and consequently sent to imaging device 110 for printing.

The kept portions in the image files may also be automatically arranged by selection and arrangement module 130 in a page to optimize the print area and minimize the number of pages to be used to print the image files (block 230). Automatic arrangement of the kept portions may be performed in accordance to one or more settings of margin space that may be placed between kept portions that are from different image files, or from different applications, as will be described in greater detail below.

Kept portions from the second image file may be placed in the modified first image file 305, as long as the kept portions from the second image file fit in the blank spaces of the modified first image file 305. In one alternative example embodiment, if the kept portions of the second image file are being appended at a bottom part of the modified first image file 305, a determination may be automatically made to check whether the kept portions may instead be started at a top portion of a next page. For example, if only a small number or percentage of rasters may fit at the bottom portion of the first page, selection and arrangement module 130 may place the kept portions on the second page.

In another alternative example embodiment, a margin may be placed between the concatenated kept portions to indicate that the concatenated kept portions are from different image files. The margin may be an appropriate number of blank rasters. In yet another alternative example embodiment, the margin may be a dividing line raster or a set of rasters that may be inserted between the kept portions. Since the image files may be generated by different applications 150, the margin inserted in the kept portions may also indicate that the kept portions may come from different applications 150. In still another alternative example embodiment, the margins may be automatically inserted between kept portions by selection and arrangement module 130. It will be understood that the margins may also be inserted by a user using a function that may be included in selection and arrangement module 130.

In some example embodiments, arranging the kept portions on a page may include modifying the positions of the kept portions to optimize the print area. Modifying the positions of the kept portions may include basic image manipulations such as changing orientation of a kept portion by rotating the kept portion in order to fit a blank space in a page or transferring a kept portion of a second image file to a first image file. Other methods of modifying the positions of the kept portions may include other image manipulation techniques that will be understood by those of ordinary skill in the art.

Referring back to FIG. 2, an arrangement of the kept portions which may include one or more margins may be stored in storage module 140 (block 235). The stored arrangement of the kept portions may be retrieved from storage module 140 by selection and arrangement module 130 for further arrangement of the kept portions, which may include deleting at least one of the kept portions or adding new kept portions from newly intercepted print jobs. For example, a user of client device 105 who wishes to concatenate kept portions from a newly generated print job may open the stored arrangement from storage module 140 and modify positions of the kept portions or add new kept portions from the newly generated print job.

At block 240, a final arrangement of the kept portions may be sent from selection and arrangement module 130 to print activation module 135 for printing. Print activation module 135 may perform similar functions as those of an imaging device driver and may render the one or more image files in their final arrangement and send the rendered image files to imaging device 110 for printing.

In one alternative example embodiment, print activation module 135 may perform the rendering and the transmitting of the final arrangement of the kept portions to imaging device 110 for printing upon instructions from the user. For example, the user may request printing of the final arrangement to begin using a Print Button which may be a physical button provided in client device 105 or a virtual button that is included in print area optimization application 115.

In another alternative example embodiment, printing of the final arrangement of the kept portions may begin automatically once certain conditions are reached. For example, if the final arrangement of the kept portions covers a sufficient amount of the page, printing may be automatically started.

In another alternative example embodiment, if the final arrangement of the kept portions contains minimal amount of blank rasters, printing may be automatically started. A specific number of blank rasters that may be considered minimal and may be used to automatically start printing of the final arrangement may be set by a user.

In another alternative example embodiment, printing may begin automatically once a kept portion of a second page is appended to a previously stored arrangement. It will be appreciated by one of ordinary skill in the art that there may be other conditions by which automatic printing may be performed.

The terms “page” and “sheet” are used interchangeably throughout this disclosure, both in relation to a single side of a piece of media. If imaging device 110 includes a two-sided (duplex) printing capability, this feature may be utilized to minimize the number of pieces of media that are used in printing. In another example embodiment, at least a portion of a first converted print job may be printed on a first side of a piece of media, and at least a portion of a second converted print job may be printed on a second side of the piece of media.

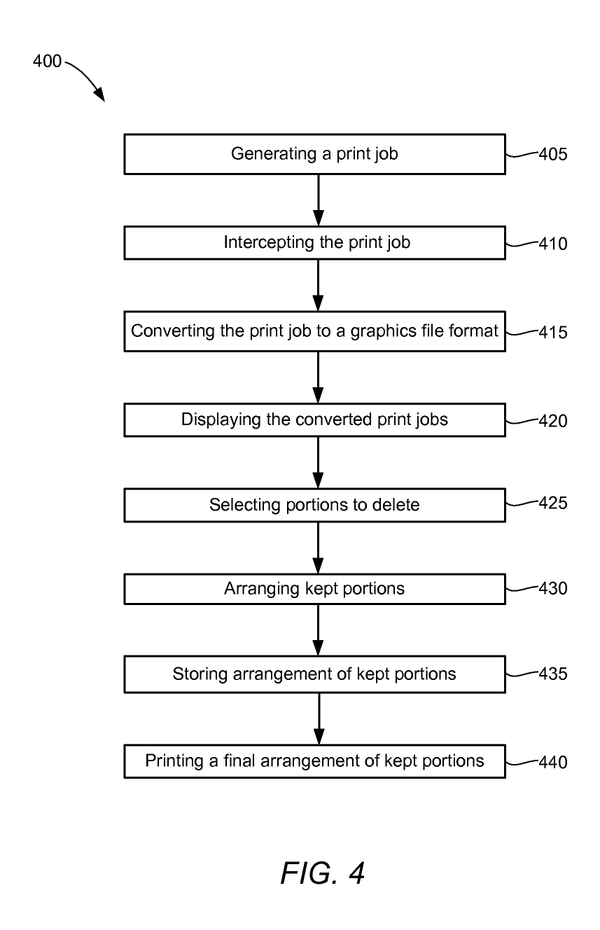

Referring to FIG. 4, there is shown one example flowchart 400 of a method of optimizing print area as performed by print area optimization application 115. At block 405, application 150 may generate a print job. As discussed above, application 150 may be a word processor that is capable of producing print jobs to be sent for imaging device 110 for printing. Application 150 may also be a web browser or an image editing application. It will be appreciated by one of ordinary skill in the art that there may be other types of applications that may be executed in client device 105 that generate print jobs to be sent to imaging device 110 for printing.

At block 410, print job interception module 120 may then intercept the print job generated from application 150. Print job interception module 120 may intercept print jobs when print area optimization application 115 is enabled in client device 105. Print job interception module 120, upon intercepting at least one print job, may keep the print jobs in a buffer. The buffer may hold print jobs sent from several different applications.

In one example embodiment, print job interception module 120 may intercept all print jobs sent to imaging device 110 for printing. In an alternative example embodiment, print job interception module 120 may intercept only print jobs that are flagged for interception. For example, print jobs generated by web browsers may be flagged for interception, and print job interception module 120 may intercept only those print jobs that were sent from web browsers for printing in imaging device 110.

In another alternative example embodiment, print job interception module 120 may only intercept print jobs that are considered short print jobs. For example, print jobs which only cover less than half a sheet of paper may be tagged as short print jobs and may be intercepted by print job interception module 120. Other characteristics of print jobs may be used as criteria to tag those print jobs for interception. Examples of other characteristics may include, but are not limited to, the color content or the estimated amount of ink or toner to be used on the print job.

The intercepted print jobs from print job interception module 120 may be transmitted to conversion module 125 which may convert the print jobs to a graphics file format, thereby generating image files with each image file corresponding to one page of the print jobs (block 415). As set forth above, the image files may be in any graphics format such as, for example, bitmap, jpeg, png or tiff. Conversion module 125 may convert each page of the print jobs such as to allow a user to perform basic image portion manipulations on each page of the print job, as will be described in greater detail below.

At block 420, the converted print jobs or the image files may be displayed in a graphical user interface. Print area optimization application 115 may be executed such that image files generated from the print jobs may be displayed such that the user of client device 105 may perform image portion manipulations on image file that corresponds to each page of the print job.

At block 425, the user may select portions in each image file that the user wishes to delete, thereby generating kept portions in each image file. It is understood that the deleted portions are portions of the print job that the user does not want include in the printed output of the generated print jobs.

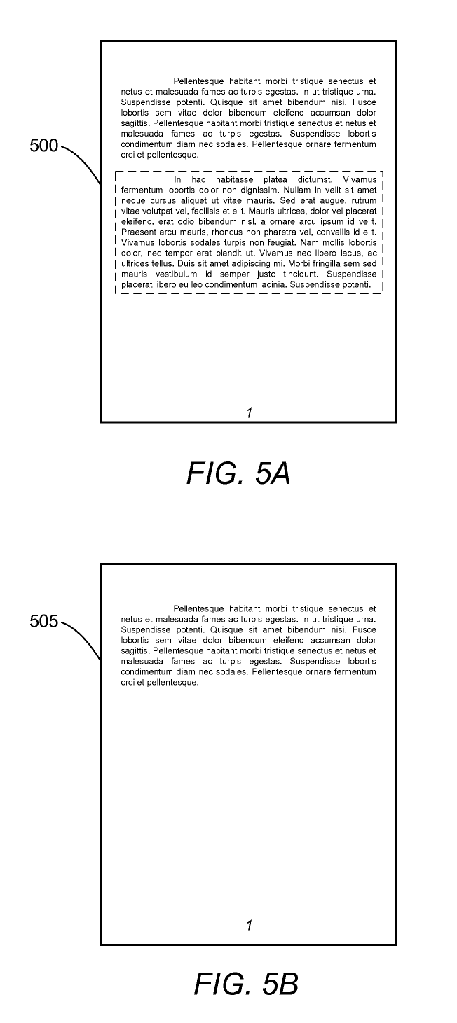

FIG. 5A and FIG. 5B illustrate an example embodiment of a user selecting portions of an image file to delete. Selection and arrangement module 130 may include a graphical user interface (GUI) tool that allows the user a basic tool of drawing a bounding box over regions of interest in a page 500 of an image file and then deleting those regions, thereby generating kept portions and a blank space in a modified page 505. The GUI tool may allow the user to gather kept portions or portions of interest in each image file and delete portions that the user wishes to omit from the print jobs, even if the print jobs have been accumulated across several applications.

With continued reference to FIG. 4, at block 430, kept options in each image file may be arranged by a user on at least one page. For example, the GUI tool that may be included in selection and arrangement module 130 may allow a user to draw a box on the kept portions and modify the positions of the kept portions.

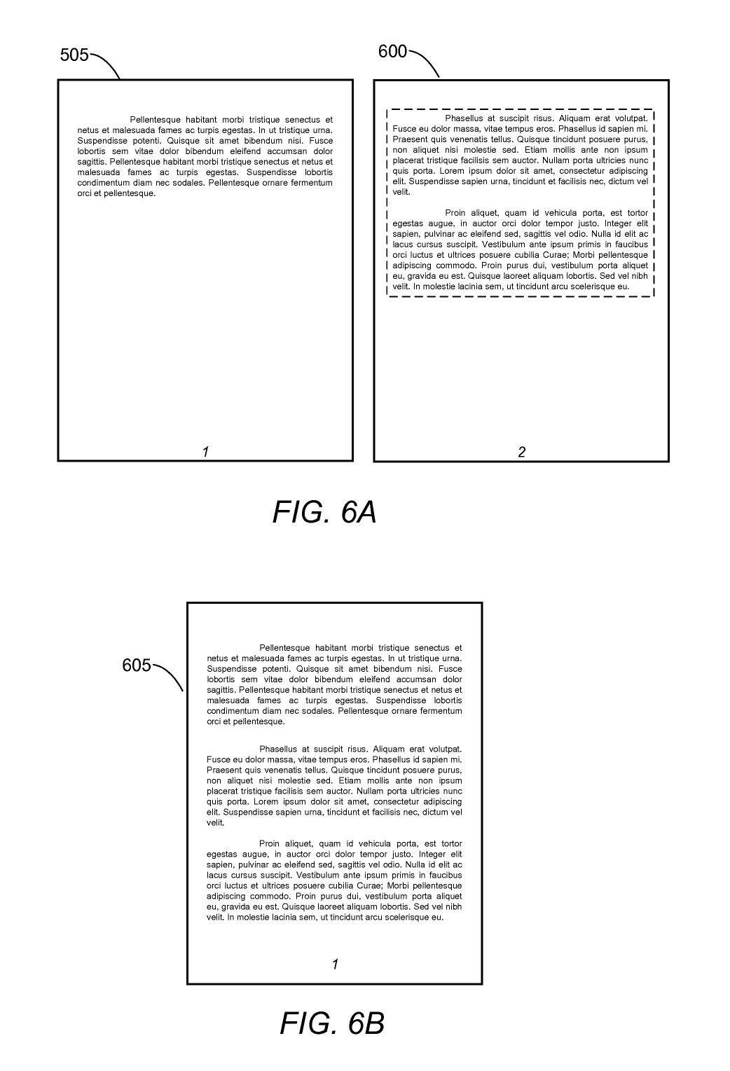

FIGS. 6A and 6B illustrate an example embodiment of modifying positions of the kept portions to allow users to optimize the print area of a page. Modified page 505 shows a print job generated from a first application with blank rasters in the bottom part. A second page 600 shows another print job which may be generated from a second application, or may be a second print job from the first application. Second page 600 contains kept portions which fit the blank space in modified page 505. The user of client device 105 may draw a box to select the kept portions in second page 600 and move the selected kept portions to the blank space of modified page 505, thereby generating a modified first page 605. Modifying the positions of the kept portions allows users to optimize the print area for each page of the printed output and minimize the number of papers to be used in a print job.

At block 435, an arrangement of the kept portions, which may include one or more margins, may be stored in storage module 140. The stored arrangement of the kept portions may be retrieved from storage module 140 by selection and arrangement module 130 for further arrangement of the kept portions, which may include deleting at least one of the kept portions or adding new kept portions from newly intercepted print jobs. For example, a user of client device 105 who wishes to concatenate kept portions from a newly generated print job may open the stored arrangement from storage module 140 and modify positions of the kept portions or add new kept portions from the newly generated print job.

At block 440, a final arrangement of the kept portions may be sent from selection and arrangement module 130 to print activation module 135 for printing. Print activation module 135 may perform similarly to an imaging device driver and may render the one or more image files in their final arrangement and send the rendered image files to imaging device 110 for printing.

In one alternative example embodiment, print activation module 135 may perform the rendering and the transmitting of the final arrangement of the kept portions to imaging device 110 for printing upon instructions from the user. For example, the user may request printing of the final arrangement to begin using a Print Button, which may be a physical button provided in client device 105 or a virtual button that is included in print area optimization application 115.

In another alternative example embodiment, printing of the final arrangement of the kept portions may begin automatically once certain conditions are reached. For example, if the final arrangement of the kept portions covers a sufficient amount of the page, printing may be automatically started.

In still another alternative example embodiment, if the final arrangement of the kept portions contains a minimal amount of blank rasters, printing may be automatically started. A specific number of blank rasters that may be considered minimal and may be used to automatically start printing of the final arrangement may be set by a user.

In yet another alternative example embodiment, printing may begin automatically once a kept portion of a second page is appended to a previously stored arrangement. It will be appreciated by one of ordinary skill in the art that there may be other conditions by which automatic printing may be performed.

The terms “page” and “sheet” are used interchangeably throughout this disclosure, both in relation to a single side of a piece of media. If imaging device 110 includes a two-sided (duplex) printing capability, this feature may be utilized to minimize the number of pieces of media that are used in printing. In another example embodiment, at least a portion of a first converted print job may be printed on a first side of a piece of media, and at least a portion of a second converted print job may be printed on a second side of the piece of media.

It will be appreciated that the actions described and shown in the example flowcharts may be carried out or performed in any suitable order. It will also be appreciated that not all of the actions described in FIGS. 2 and 4 need to be performed in accordance with the embodiments of the disclosure and/or additional actions may be performed in accordance with other embodiments of the disclosure.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of optimized printing, comprising:
accumulating a plurality of print jobs from at least one application, each of the plurality of print jobs containing print content;
converting each of the plurality of print jobs to an image format;
automatically arranging the print content of each of the converted print jobs, and
printing at least a portion of a first converted print job of the plurality of print jobs and at least a portion of a second converted print job of the plurality of print jobs on a single media sheet.

2. The method of claim 1, wherein the automatically arranging includes automatically concatenating the print content from the second converted print job to the first converted print job.

3. The method of claim 1, further comprising inserting a margin between the print content from the second converted print job and the print content in the first converted print job.

4. The method of claim 1, wherein the automatically arranging includes removing blank rasters in at least one of the converted print jobs.

5. The method of claim 1, wherein the automatically arranging includes deleting portions of the print content in at least one of the converted print jobs.

6. The method of claim 1, wherein the automatically arranging includes deleting portions of the print content selected by a user in at least one of the converted print jobs.

7. The method of claim 1 wherein the automatically arranging includes modifying positions of the print content.

8. The method of claim 1, further comprising intercepting the plurality of print jobs sent from the at least one application to an imaging device prior to the accumulating the plurality of print jobs.

9. The method of claim 8, wherein the intercepting of the plurality of print jobs is performed on short print jobs.

10. The method of claim 8, wherein the intercepting of the plurality of print jobs is performed on print jobs generated from a specific application.

11. The method of claim 1, further comprising storing an arrangement of the print content.

12. The method of claim 1, further comprising retrieving a stored arrangement of the print content.

13. A computing device with a non-transitory computer-readable storage medium containing computer executable instructions to:
accumulate a plurality of print jobs from at least one application, each of the plurality of print jobs containing print content;
convert each of the plurality of print jobs to an image format;
automatically arrange the print content of each of the converted print jobs, and print at least a portion of a first converted print job of the plurality of print jobs and at least a portion of a second converted print job of the plurality of print jobs on a single media sheet.

14. The computing device of claim 13, wherein the automatically arranging includes concatenating the print content from a second converted print job to a first converted print job.

15. The computing device of claim 13, further comprising the computer executable instructions to automatically print the converted print jobs once the print content from the second converted print job is concatenated to the first converted print job.

16. The computing device of claim 13, further comprising the computer executable instructions to automatically print the converted print jobs once the single media sheet contains less than a specified number of blank rasters.

17. The computing device of claim 13, wherein the automatically arranging includes deleting portions of the print content in at least one of the converted print jobs.

18. The computing device of claim 13, wherein the automatically arranging includes removing blank rasters in at least one of the converted print jobs.

19. The computing device of claim 13, further comprising the computer executable instructions to modify positions of the print content in a first page in at least one of the plurality of print jobs.

20. A method of optimized printing, comprising:
accumulating a plurality of print jobs from at least one application, each of the plurality of print jobs containing print content;
converting each of the plurality of print jobs to an image format;
automatically arranging the print content of each of the converted print jobs, and
printing at least a portion of a first converted print job of the plurality of print jobs on a first side of a piece of media and at least a portion of a second converted print job of the plurality of print jobs on a second side of the piece of media.
